(19) United States
(12) Patent Application Publication
(10) Pub. No.: US 2008/0187188 A1
(43) Pub. Date: Aug. 7, 2008

(54) Systems, apparatuses and methods for facilitating efficient recognition of delivered content

(76) Inventors: Oleg Beletski, Espoo (FI); Niklas Von Knorring, Espoo (FI); Marcel Keppels, Masala (FI); Cristina Dobrin, Helsinki (FI); Saket Gupta, Helsinki (FI); Jukka Heinonen, Helsinki (FI)

Correspondence Address: Hollingsworth & Funk, LLC, Suite 125, 8009 34th Avenue South, Minneapolis, MN, 55425, US

(21) Appl. No.: 11/703,439

(22) Filed: Feb. 7, 2007

(51) Int. Cl. G06K 9/00

(52) U.S. Cl. 382/124

(57) ABSTRACT

Systems, apparatuses and methods for enhancing media fingerprint calculations by distributing the fingerprinting task among multiple terminals. A fingerprinting task is distributed among a plurality of terminals by calculating a plurality of different fingerprints or fingerprint portions of a media stream at a plurality of terminals. A stream of fingerprints can thereby created based on the fingerprints or fingerprint portions provided by the terminals involved in the fingerprinting task distribution. Content associated with the media stream is identified using the content fingerprint. In this manner, the content can be identified and provided to the multiple terminals, while distributing the fingerprinting task among the multiple terminals.

### FIELD OF THE INVENTION

This invention relates in general to delivered content identification, and more particularly to systems, apparatuses and methods for facilitating efficient recognition of delivered content.

### BACKGROUND OF THE INVENTION

When originally introduced into the marketplace, analog mobile telephones used exclusively for voice communications were viewed by many as a luxury. Today, mobile communication devices are highly important, multi-faceted communication tools. A substantial segment of society now carries their mobile devices with them wherever they go. These mobile devices include, for example, mobile phones, Personal Digital Assistants (PDAs), laptop/notebook computers, and the like. The popularity of these devices and the ability to communicate “wirelessly” has spawned a multitude of new wireless systems, devices, protocols, etc. Consumer demand for advanced wireless functions and capabilities has also fueled a wide range of technological advances in the utility and capabilities of wireless devices. Wireless devices not only facilitate voice communication, but also messaging, multimedia communications, e-mail, Internet browsing, and access to a wide range of wireless applications and services.

More recently, wireless communication devices are increasingly equipped with other media capabilities such as radio receivers. Thus, a mobile phone can be equipped to receive amplitude modulated (AM) radio and/or frequency modulated (FM) radio signals, which can be presented to the device user via a speaker or headset. With the processing power typically available on such a mobile communication device, broadcast radio can be a more rich experience than with traditional radios. For example, a terminal (e.g., mobile phone, PDA, computer, laptop/notebook, etc.) is often equipped with a display to present images, video, etc. Terminals are also often capable of transmitting and/or receiving data, such as via GSM/GPRS systems or otherwise. These technologies enable such terminals to present images, video, text, graphics and/or other visual effects in addition to presenting the audio signal received via the radio broadcast. For example, the song title, artist name and/or other information relating to a song broadcast from a radio station can be provided to a terminal for visual presentation in addition to the audio presentation.

Currently, such a “visual radio service” is provided by a limited number of radio stations that are integrated with the visual radio content creation tools. A first problem involves the inability to provide visual radio content (e.g., song title, artist name, etc.) for any radio station that the broadcast radio-equipped terminal is capable of listening to. One current approach is that such a service has to be “integrated with” each radio station separately, and great effort is required to keep such a visual service running. Only those radio stations where visual radio is integrated with the radio automation system can deliver such a service. It is difficult to provide tight synchronizations in the case of a last minute change in a schedule of radio station.

One manner of addressing such a problem is to utilize song identification techniques. If a terminal can identify the song that is being played on the radio, this knowledge can be used to gather additional information relating to the song. However, such identification can be extremely processor intensive, which consumes processing power and adversely affects terminal battery life. Further, all of the song identification data created by every mobile device may unnecessarily consume a substantial quantity of bandwidth if sent from the terminals, which may also cost the terminal user financially for data communications volumes and/or times. Additionally, if the song identification takes a significant amount of time to develop, and/or takes a significant amount of time en route on a network, an unacceptable delay in presenting any visual radio information may occur.

Accordingly, there is a need in the industry for a manner of reducing the load on terminals, network elements and/or the network generally where accompanying data is provided in connection with radio and/or other media broadcasts. The present invention fulfills these and other needs, and offers other advantages over the prior art.

### SUMMARY OF THE INVENTION

To overcome limitations in the prior art described above, and to overcome other limitations that will become apparent upon reading and understanding the present specification, the present invention discloses systems, apparatuses and methods for enhancing media fingerprint calculations by distributing the fingerprinting task among multiple terminals.

In accordance with one embodiment, a method is provided including distributing a task of calculating a plurality of fingerprint portions corresponding to a media stream among a plurality of terminals. The plurality of calculated fingerprint portions is aggregated to create a stream(s) of fingerprints. Content corresponding to the media stream is identified using at least a portion of the stream of fingerprints.

According to one embodiment of such a method, one or more of the fingerprint portions include partial fingerprints forming less than a complete fingerprint, and aggregating the plurality of calculated fingerprint portions involves deriving at least one complete fingerprint based on an aggregation of a plurality of the partial fingerprints. In another embodiment, one or more of the fingerprint portions include complete fingerprints each capable of identifying the media stream.

In another embodiment of the method, aggregating the plurality of calculated fingerprint portions involves forming an end-to-end chain of the calculated fingerprint portions from the plurality of terminals to create a substantially continuous stream of the fingerprints. In a more particular embodiment, identifying content corresponding to the media stream involves using the substantially continuous stream of fingerprints to identify changes in the media stream. In still another particular embodiment, using the substantially continuous stream of fingerprints to identify changes in the media stream involves identifying a change from one media item to another media item based on a change in the substantially continuous stream of fingerprints provided by the plurality of terminals.

Another embodiment of such a method involves distributing the task of calculating a plurality of fingerprint portions by distributing the calculation task of an over-the-air radio broadcast among the plurality of terminals, and where identifying content corresponding to the media stream involves identifying visual information associated with an audio track of the radio broadcast being presented on the plurality of terminals. In one particular embodiment, it is further determined which terminals are tuned to the radio broadcast to identify the plurality of terminals that will calculate the plurality of fingerprint portions.

One embodiment of such a method further includes transmitting the plurality of calculated fingerprint portions in a single fingerprint stream :for remote identification of the content associated with the media stream. In an alternative embodiment, the method involves transmitting the plurality of calculated fingerprint portions in a plurality of fingerprint streams facilitate parallel identification of the content associated with the media stream. In one particular embodiment, transmitting multiple fingerprint streams in parallel involves temporally overlapping the calculated fingerprint portions of the plurality of fingerprint streams.

In another embodiment of such a method, the identified content is transmitted to each of the plurality of terminals involved in the calculation of the fingerprint portions. In still another embodiment, calculating a plurality of fingerprint portions of different content fingerprint portions involves each of the plurality of terminals generating one or more different digital packets of information indicative of respective audio segments of the media stream occurring at different time intervals. In one embodiment, one or more of the different fingerprint portions includes at least some overlapping fingerprint data.

In accordance with another embodiment of the invention, a method is provided that includes receiving an over-the-air media stream including at least an audio component. A subset of the audio component that has been allocated for processing is identified. At least one digital fingerprint is calculated for the identified subset of the audio component, and the digital fingerprint(s) is transmitted.

In one embodiment of such a method, identifying a subset of the audio component that has been allocated for processing involves identifying the subset of the audio component in response to receipt of a fingerprint distribution notification. In a more particular embodiment, the fingerprint distribution notification is received from a server via a network. One particular embodiment involves transmitting the calculated digital fingerprint(s) to a processing system capable of recognizing a fingerprint stream including the calculated digital fingerprint(s) and other calculated digital fingerprints based on other subsets of the audio component.

In one embodiment, receiving an over-the-air media stream including at least an audio signal comprises receiving a radio broadcast signal of a song, and wherein identifying a subset of the audio component comprises identifying one or more time intervals of the song in which a respective one or more digital fingerprints are to be calculated. One embodiment involves transmitting one or more of the calculated digital. fingerprints as time multiplexed portions of a single fingerprint stream, while another embodiment involves transmitting one or more of the calculated digital fingerprints as time multiplexed portions of multiple fingerprint streams.

In one particular embodiment of such a method, at least the audio component of the media stream is audibly presented, content identified in response to the transmission of the at least one digital fingerprint is received, and the received content is presented during at least some of the audible presentation of the audio component of the media stream.

In another embodiment, the method is carried out via a mobile terminal, and a radio landscape data set is provided including information indicative of a location of the mobile terminal. In another embodiment, it is determined when to create the digital fingerprint(s). One embodiment of such a method includes transmitting location parameters, receiving an indication of a current location generated in response to the location parameters, and identifying a globally-unique radio station identifier to which a radio receiver is tuned based on the current location and a frequency to which the radio receiver is tuned.

In accordance with another embodiment, a method is provided that includes receiving a plurality of content fingerprint portions from a plurality of mobile terminals, where each content fingerprint portion representative of a portion of a media stream. Digital information is located using one or more of the plurality of content fingerprint portions, and the located digital information is transmitted for use by the plurality of mobile terminals.

In one embodiment of such a method, one or more of the content fingerprint portions comprise partial fingerprints forming less than a complete fingerprint, and aggregating the plurality of calculated fingerprint portions involves deriving at least one complete fingerprint based on an aggregation of a plurality of the partial fingerprints. In another embodiment, one or more of the content fingerprint portions comprise complete fingerprints each capable of identifying the media stream.

One embodiment of the method involves notifying the mobile terminals to which portion of the media stream it should create a partial content fingerprint. In one embodiment, receiving a plurality of partial content fingerprints involves: receiving the plurality of partial content fingerprints via a single data stream, while in another embodiment receiving a plurality of partial content fingerprints involves receiving the plurality of partial content fingerprints via multiple parallel data streams. In one embodiment, receiving the plurality of partial content fingerprints via multiple parallel data streams involves receiving a first data stream of concatenated fingerprint samples, and receiving one or more second data streams different concatenated fingerprint samples. In a particular embodiment, the concatenated fingerprint samples from the first and second data streams are temporally overlapping.

Other embodiments of such a method include aggregating at least some of the partial content fingerprints, and determining a radio station to which each of the plurality of terminals is tuned.

In accordance with one embodiment, an apparatus is provided that includes a radio receiver to receive an over-the-air media stream, a fingerprint extraction module configured to sample a subset of the media stream, a fingerprint calculation module to generate fingerprints for each of the portions sampled, and a transmitter to transmit the generated fingerprints.

In one embodiment, a data receiver is provided to receive content related to the media stream and identified using the transmitted fingerprints. In a more particular embodiment, a display visually presents the received content related to the media stream, and in another embodiment a speaker audibly presents the received media stream contemporaneously with the visual presentation of the received content. One embodiment includes the transmitter further transmitting radio landscape data including information indicative of a geographic location of the apparatus.

In accordance with one embodiment, an apparatus is provided that includes a receiver to receive a plurality of fingerprints from a respective plurality of terminals, where each fingerprint at least partly representative of a media stream. The apparatus also includes a processing module configured to locate digital information in a database based on the plurality of fingerprints, and a transmitter to transmit the digital information for use by the plurality of terminals.

The above summary of the invention is not intended to describe every embodiment or implementation of the present invention. Rather, attention is directed to the following figures and description which sets forth representative embodiments of the invention.

### BRIEF DESCRIPTION OF THE DRAWINGS

The invention is described in connection with the embodiments illustrated in the following diagrams.

FIG. 1 is a block diagram generally illustrating one embodiment of a manner for distributing a media fingerprinting task in accordance with the invention;

FIGS. 2A, 2B and 2C are flow diagrams depicting various representative manners for calculating fingerprints used to identify associated media content;

FIGS. 3A and 3B are block diagrams illustrating exemplary manners for distributing audio fingerprint calculation tasks among a plurality of terminals according to embodiments of the invention;

FIG. 4A illustrates an example of the user's interaction to select a radio or other media station, and in some cases to confirm the station via corroborative information;

FIG. 4B illustrates a table of representative information that may be used to determine the globally-unique radio channel identity;

FIG. 5 is a block diagram generally illustrating the use of a control channel and corresponding control protocol to distribute the fingerprinting task among a plurality of terminals;

FIG. 6A illustrates an exemplary manner of recognizing fingerprints to identify an audio item in accordance with the invention;

FIG. 6B illustrates an example of sharing the fingerprint distribution task;

FIG. 7A illustrates an example of providing multiple streams of fingerprints to facilitate faster recognition at the recognition backend;

FIG. 7B illustrates a representative example of using multiple streams of fingerprints and also distributing the fingerprinting task among a plurality of terminals;

FIG. 8 illustrates a representative system(s) in which the present invention may be implemented or otherwise utilized.

### DETAILED DESCRIPTION OF EMBODIMENTS OF THE INVENTION

In the following description of exemplary embodiments, reference is made to the accompanying drawings which form a part hereof, and in which is shown by way of illustration various manners in which the invention may be practiced. It is to be understood that other embodiments may be utilized, as structural and operational changes may be made without departing from the scope of the present invention.

Generally, the present invention provides systems, apparatuses and methods for enhancing media fingerprint calculations by distributing the fingerprinting task among multiple terminals. Media such as radio or other audio may be transmitted via a transmission frequency or channel, where multiple mobile terminals may located such that they can be tuned or otherwise capable of recognizing the media via that frequency/channel. For example, a radio station may transmit a radio signal, and a plurality of mobile terminals within a transmission range are tuned to the same station to receive that radio signal. In such cases, media fingerprint calculations may be distributed among a plurality of the receiving terminals in accordance with the invention.

The description provide herein often refers to radio content (e.g., broadcast radio such as AM/FM radio) as a media type, but it should be recognized that the present invention is equally applicable to any type of transmitted media. In one embodiment, the invention provides approaches to content generation that allows a visual radio service (e.g., NOKIA Visual Radio Service™) for any radio station that is received by a mobile terminal. These radio stations may be any type, such as frequency modulated (FM), amplitude modulated (AM), etc. As used herein, visual radio (or analogously, visual media) involves any visually presented information associated with the audio transmission, such as the song title, artist, album cover art, advertiser/product, and/or other information that may correlate to the provided audio transmission.

Presently, a visual radio service can be provided for a limited number of stations that are equipped with visual radio content creation tools. However, it would be desirable to provide such visual radio content for any radio/media station and not only for those that have been equipped with specific visual radio content tools. The present invention provides, among other things, manners for providing data such as visual radio content to any mobile terminal equipped with a receiver module(s) capable of receiving and presenting the audio and visual content. If each receiving terminal is responsible for assisting in song/media recognition in the radio/media program, there is duplication of such efforts that consumes bandwidth, battery power, etc. The present invention addresses manner of reducing the load on the terminal, network, server and/or other such components of the system.

One embodiment of the invention proposes manners for enabling content generation for services such as visual radio services, without the otherwise required integration with radio station content automation systems. One embodiment involves using song recognition technology, where the mobile terminal calculates the audio fingerprint and provides it to a server(s) for recognition and content creation. Generally, “fingerprinting” is a technique used for song identification. Fingerprints are smaller than the actual digital content but contain enough information to uniquely identify the song or other media item. Each audio fingerprint is unique and can be used to precisely identify a song or other media item. Any known “fingerprinting” technology may be used in connection with the invention.

After receiving the fingerprint and identifying the music piece or other audio, the visual radio server can send content that matches the currently broadcast song or other media item to the terminal. In accordance with the invention, the fingerprint calculation is distributed among multiple terminals based on the fact that there can be several mobile terminals tuned to the same station in the area.

In order to generate the visual content with the radio or other media broadcast, the fingerprinting task is performed relatively continuously, or at least repetitively, in accordance with one embodiment of the invention. By continuously and/or repeatedly recognizing the broadcast content, a song (or other media itern) change can be readily determined. By recognizing the song change, visual content for the terminated song can be discontinued, and a new portion of visual content can be created for the new song. Under normal circumstances, a single fingerprint from a terminal may be sufficient to identify the song/media item. Thus, as described more fully below, the fingerprint(s) received from each one of the plurality of collaborating terminals may be sufficient to identify the song or other media item.

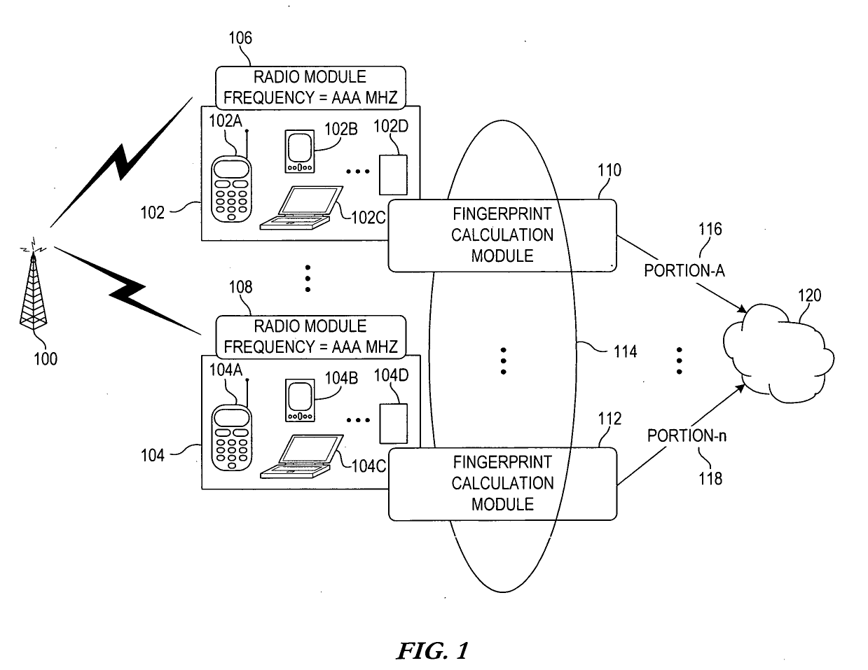

FIG. 1 is a block diagram generally illustrating one embodiment of a manner for distributing a media fingerprinting task in accordance with the invention. FIG. 1 is described in terms of an FM radio broadcast, but the description is equally applicable to other transmissions capable of recognition at the recipient terminals. A radio signal is broadcast or otherwise transmitted from a radio station (or other transmitting element) 100. The signal is received by multiple mobile terminals within a transmission range of the radio station 100 that are tuned to the relevant radio frequency. FIG. 1 shows two such terminals 102, 104, although any additional number of mobile terminals may be involved. In the illustrated embodiment, each of the terminals 102, 104 can represent any mobile communication device such as, for example, a mobile phone 102A/104A, personal digital assistant 102B/104B, portable computing device 102C/104C or other communication device 102D/104D. The terminals 102, 104 respectively include radio modules 106, 108 which can be tuned to the relevant frequency to receive the radio signals.

Based on the received radio signal, each terminal 102, 104 can invoke a fingerprint calculation module 110, 112 which will collectively serve as the fingerprint calculation functionality 114. For example, the fingerprint calculation module 110 associated with the terminal 102 can calculate a first fingerprint portion-A 116, and an n^{th} terminal 104 can calculate an n^{th} fingerprint portion 118. Collectively, the fingerprint portions 116, 118 can provide sufficient fingerprint information to enable a server or other module to identify the media and return the visual information or other related data. The portions 116, 118 may be provided to the server or other module via a network 120, and/or may be provided in other known manners including but not limited to infrastructure-based networks (e.g., Internet, LAN, etc.), proximity networks (e.g., Bluetooth, WLAN, peer-to-peer networking, etc.), cellular networks (e.g., GSM/GPRS, etc.), direct connections (e.g., USB, firewire, etc.) and the like. While the fingerprint calculation modules 110, 112 need not be physically part of their respective terminals 102, 104, one embodiment of the invention involves physically embedding these modules/functionality 110, 112 within their respective terminals.

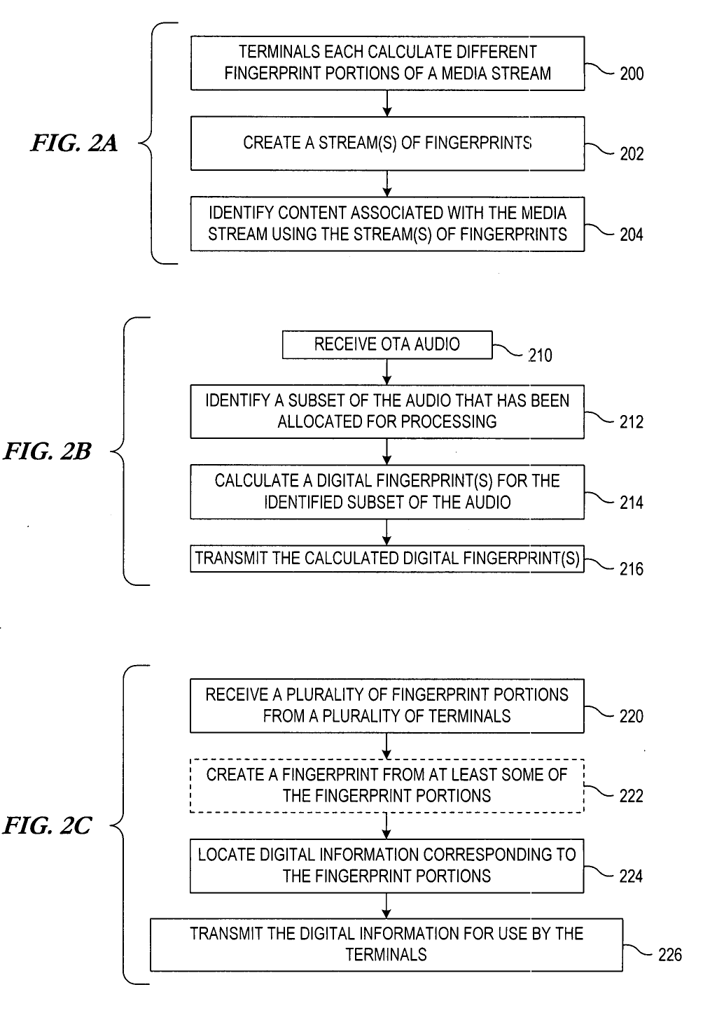

FIGS. 2A, 2B and 2C are flow diagrams depicting various representative manners for calculating fingerprints used to identify associated media content. FIG. 2A is a flow diagram depicting one embodiment of a method for distributing a fingerprinting task in accordance with the present invention. A plurality of terminals each calculate different fingerprint portions of a media stream, as shown as block 200. While some terminals may calculate the same fingerprint portions, at least a plurality of terminals calculate different fingerprint portions. Being “different” in this sense does not imply that there is no overlap at all, but rather that at least some of the media stream subject to the fingerprint portion calculation by one terminal is different than at least some of the media stream subject to the fingerprint portion calculation by another terminal(s). For example, one terminal can calculate a fingerprint portion for the first five seconds of an audio stream, while another terminal can calculate a fingerprint portion for a five second interval beginning at the end of the fourth second of the audio stream. While there may be some overlap in fingerprint generation (e.g., the fifth second of the audio stream), the fingerprint portions calculated by the two terminals are different. In one embodiment, each terminal itself calculates the fingerprint portions. Further, the fingerprint “portions” can represent incomplete portion of a fingerprint (e.g., one half of a complete fingerprint), or can represent complete fingerprints where the “portions” thus refer to the individual complete fingerprints of the multiple complete fingerprints forming a stream of fingerprints.

A stream of fingerprints is created 202. For example, one terminal can create a first fingerprint, and a second terminal can create a second fingerprint. A stream of fingerprints can be formed from the first and second fingerprints. In a more particular example, two or more terminals may calculate fingerprint portions at alternating time intervals of an audio signal, where the resulting calculations are used to derive an aggregate fingerprint capable of identifying the audio signal to a downstream entity (e.g., a music recognition server). While in one embodiment the “stream” of fingerprints is represented by an end-to-end chain of the fingerprints, a “serial” stream is not required, as parallel streams may additionally or alternatively be used.

In another embodiment, a fingerprint may be derived based on an aggregation of calculated fingerprint portions, where at least some of the portions represent an incomplete portion of a complete fingerprint. Such a derivation may be performed by, for example, assembling the resulting incomplete fingerprint portions in an order corresponding to the original audio stream from which the fingerprint portions were calculated. Thus, by concatenating the incomplete fingerprint portions from the plurality of terminals in the proper order, the resulting derived fingerprint can be substantially the same as if a single terminal generated the entire, complete fingerprint. In one embodiment, a server or other processing system receives the fingerprint portions and derives the resulting fingerprint, although the terminal or other entity can create the resulting fingerprint.

Using the received fingerprints, content associated with the media stream can be identified 204. By repeatedly sending such fingerprints, it can be determined when the media stream changes such that any returned content should be changed. For example, by continuing to calculate fingerprints, it can be determined when a radio broadcast song has ended and a new song has begun. In one embodiment, a database of content is stored, where the fingerprints are used to ultimately locate the data in the database that corresponds to that fingerprint. This database can be stored in a stand-alone terminal, server, etc. This database can alternatively be stored in a distributed server system, and/or in other distributed systems including any one or more of the terminal, server, etc. In one embodiment, the content is stored in a database associated with a server, where the derived fingerprint is used to index the database to obtain the associated content. This content may be any content associated with the media stream. For example, where a radio broadcast represents the media stream, the “content” may be visual radio content such as a song title, author, album cover art, artist photos or images, related trivia, artist biographies, and/or any other information that may pertain to the current media stream item. In other embodiments, the content may not specifically relate to the current media stream item (e.g., song), but may represent other content such as advertisements, coupons or discounts, “next song” indications, etc.

As indicated above, the fingerprint(s) can ultimately be used to identify the desired content, such as the desired visual content associated with a song received at a terminal via a radio broadcast. For example, the fingerprint(s) can be used to identify a song or other media identifier (ID), where that ID is internal to the recognition system. Then, song/media metadata or other such data can be identified, such as an artist name, title, album name, etc. Using the song/media metadata, the related content in a database can be identified. In another embodiment, the related content may be directly linked to the song/media ID. In another embodiment, the content may be directly obtained using the fingerprint. Any manner of ultimately identifying the desired content using the fingerprint(s) may be used in accordance with the present invention. Thus, where the present description indicates that content may be obtained or otherwise identified using the fingerprint, this does not imply that the fingerprint is used to directly obtain the desired content (e.g., visual radio content). Rather, the use of the fingerprint to obtain or otherwise identify the desired content can be direct or indirect use of the fingerprint, and reference herein to using the fingerprint to obtain/identify the data is not limited to any particular direct or indirect way of using the fingerprint in this manner.

FIG. 2B is a flow diagram illustrating an exemplary embodiment of a method performed at a terminal to facilitate the fingerprint distribution of the invention. A media stream including an audio component is received 210 over-the-air (OTA). For example, this media stream may be received via a radio broadcast. A subset of the audio component that has been allocated for processing is identified 212. For example, where the fingerprinting task is to be distributed between two terminals tuned to the same radio station, the terminal identifies which portion(s) of the audio component it is to subject to fingerprint generation. The other terminal(s) may identify other portions of the audio component, thereby enabling the task to be distributed among multiple terminals. For example, the allocation may simply be that the terminals take turns calculating a fingerprint (which may be a complete or incomplete fingerprint). The terminal calculates 214 a digital fingerprint portion(s) for the identified subset of the audio or other media component. For example, the terminal may calculate a digital fingerprint for a first time interval (e.g., eight seconds starting from the beginning of the song), then for a second time interval (e.g., eight seconds starting from the sixteenth second of the song), and so forth. The calculated digital fingerprint portion(s) is then transmitted 216.

A recipient device may use the information to create an aggregate fingerprint from the various fingerprint portions, and identify the song or other media item to which the aggregate fingerprint is associated with. When the song or other media item is identified, then content associated therewith (e.g., song title, artist, etc,) can be provided.

FIG. 2C is a flow diagram illustrating an exemplary embodiment of a method performed at a network element to facilitate the fingerprint distribution of the invention. In one embodiment, each of the content fingerprints corresponds to a portion of a media stream, and thus is representative of that media stream. A plurality of content fingerprints (which may be complete or incomplete fingerprints) are received 220 from a plurality of terminals. Where at least some of the fingerprints represent partial, incomplete fingerprints, a complete fingerprint may be created from the partial fingerprints as depicted at block 222. For example, a network element may concatenate a plurality of partial content fingerprints in an order corresponding to the order of the media stream to create an aggregate fingerprint. In either case of complete or created fingerprints, digital information corresponding thereto may be located 224, such as located in a database or other storage element(s). Upon locating this information, it may be transmitted for use by the plurality of terminals.

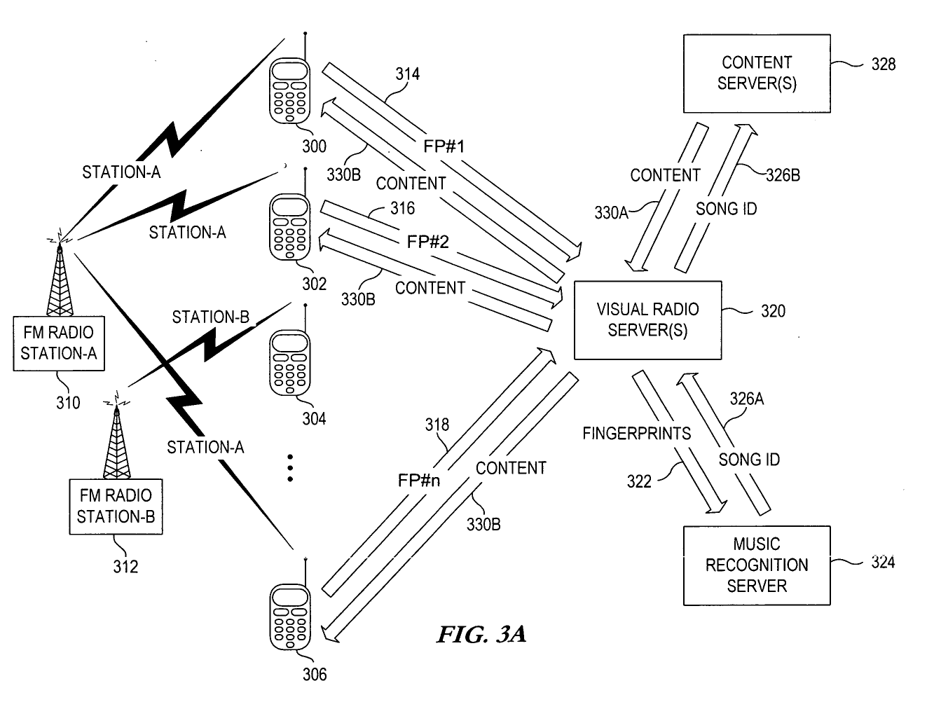

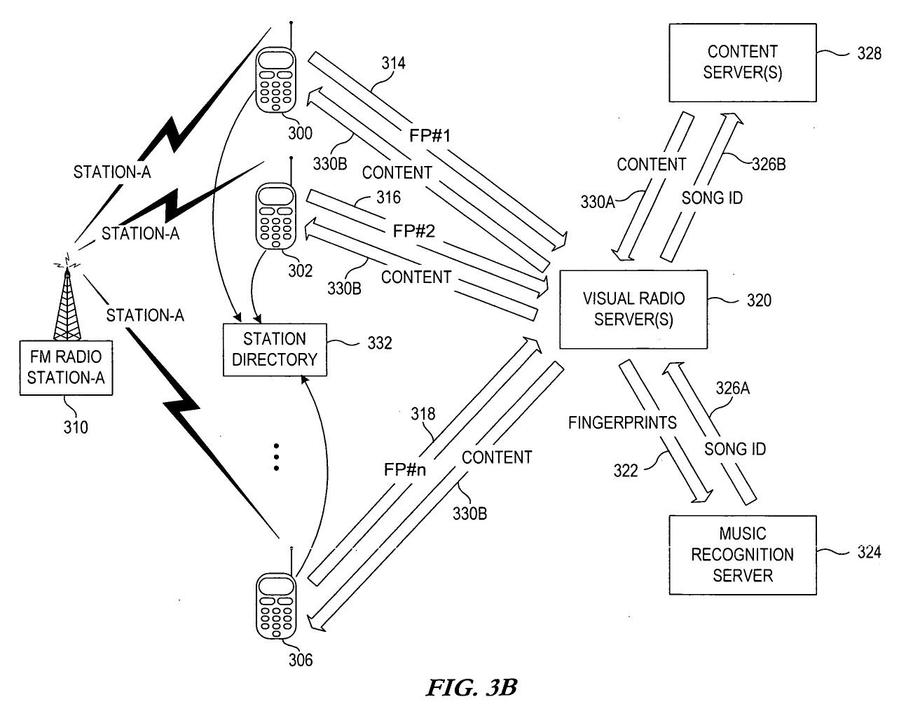

FIG. 3A is a block diagram illustrating a manner for distributing audio fingerprint calculation tasks among a plurality of terminals according to one embodiment of the invention. This embodiment recognizes that multiple terminals 300, 302, 306 may be tuned to the same station. In the illustrated embodiment, at least two of the mobile terminals tuned to the same station will collaboratively calculate the fingerprints. This results in decreasing the overall fingerprint calculation task at any one of the terminals. For example, the amount of calculation can be reduced by approximately N, where N represents the number of mobile terminals currently tuned to the same station. Various manners of determining whether the terminals are tuned to the same station may be implemented as will be described more fully below.

By distributing the fingerprint calculation task, the recognition can be more reliable since several fingerprint streams can be used which can overcome the limitation of recognition algorithms that can start the identification after the fingerprint data collection period. Further, fingerprint calculation reduces stress on the batteries of each of the calculating devices since the processor-intensive fingerprinting operations will be reduced. Fingerprint distribution also potentially provides for better overall quality fingerprinting because some devices can obtain a better signal than others. For example, a terminal remote from the radio station may benefit by having other closer terminals provide a portion of the aggregate fingerprint. The distribution of the fingerprinting task can also result in less network traffic, which conserves network capacity/bandwidth, and results in less cost for users that pay by transmission time and/or transmitted data volume. The receiving server(s) can also benefit because, for example, it theoretically only has to handle one (or at least fewer) distributed stream of fingerprints per station rather than N streams (where N represents the number of terminals tuned to the same radio station).

It should be noted that the collaboration in generating the fingerprint does not imply or require precision in the allocation of this task; i.e., there cart be gaps or overlap in the calculation. For example, one mobile terminal can begin calculating at an approximate point in a radio station-received song, and another mobile terminal can begin calculating at another point although some overlap or gap occurs, as long as the resulting fingerprint provides enough data for a receiving module to use the fingerprint portions to identify the song, advertisement or other media that was received by the mobile terminals.

In the embodiment illustrated in FIG. 3A, numerous mobile terminals are tuned to the signal at FM radio station-A 310, including mobile terminals 300, 302 and 306. Other mobile terminals in the area may be tuned to other stations, such as is depicted by mobile terminal 304 that is tuned to radio station-B 312 frequency. For purposes of example, the devices tuned to FM radio station-A 310 are considered. These devices, including at least terminals 300, 302 and 306, each calculate a portion(s) of the fingerprint that will ultimately be used to identify the media (e.g., song) currently playing via the mobile terminals 300, 302, 306. In this way, it is possible to distribute the load of fingerprint calculations between these terminals. For example, if N terminals are tuned to the same radio station-A 310, each of these terminals 300, 302, 306 calculates and sends every N^{th} fingerprint portion of the total stream. Particularly, terminal 300 sends a first fingerprint portion (FP#1) 314, and terminal 302 sends a second fingerprint portion (FP#2) 316. Additional terminals can be involved, up to N terminals as represented by the n^{th} fingerprint portion (FP#n) 318. In this manner, each of the participating terminals calculates the fingerprints, where in one embodiment each terminal calculates the fingerprints in collaboration with the other terminals and thus has to do it less often.

Each mobile terminal that is involved in the distributed fingerprint calculation may determine the fingerprints at certain times or in connection with a certain event(s). For example, the terminals tuned to and within a reasonable receiving range of a common station can periodically calculate the fingerprints, such as every X seconds. The distributed fingerprint calculation may also be initiated at each participating terminal upon occurrence of a triggering event. One such triggering event can be a time, such as 09:10:15, 09:10:20, 09:10:25, etc. Such triggering times or durations may be adjusted depending on the number of mobile terminals tuned to the particular station. For example, the more participating terminals, the fewer times a particular terminal needs to perform its calculation. Other triggering events may include, for example, receipt of a triggering signal, recognized events such as recognizing a gap in the audio that could indicate changing from one song to another, etc. Many other events may be implemented to initiate the distributed calculation in each of the participating devices.

In the illustrated embodiment of FIG. 3A, the fingerprint portions FP#1 314, FP#2 316 through FP#n 318 are provided to a system for managing the recognition and return delivery of the content. For example, the fingerprint portions 314, 316, 318 may be provided via a network(s) to a network element(s) such as a visual radio server(s) 320. The representative visual radio server 320 can provide the fingerprints 322 to a content recognition server 324 using the fingerprint portions from the terminals 314, 316, 318. In response, the content recognition server 324 can provide a content identification, such as a song ID 326A in the case of a music recognition server 324. The visual radio server 320 can then provide the song ID 326B to a content server 328 to obtain the associated content 330A. The content 330B is then provided to the terminals 300, 302, 306.

It should be recognized that the “servers” 320, 324, 328 represent any entity capable of providing the noted services. The servers 320, 324, 328 can be discrete elements, or can be partially or completely combined into one or more servers. The servers may be accessible via any known manner, such as by way of a network(s) and/or via direct wired or wireless connections. The servers may be stand-alone or distributed. Accordingly, the illustrated representation of the servers 320, 324, 328 is intended to facilitate an understanding of one representative embodiment of a content delivery mechanism, but the invention is clearly not limited to any particular arrangement or structure of servers.

FIG. 3B is a block diagram illustrating another representative manner for distributing audio fingerprint calculation tasks among a plurality of terminals in accordance with the invention. Like reference numbers to those of FIG. 3A are used in FIG. 3B. The embodiment of FIG. 3B recognizes that multiple terminals 300, 302, 306 may be tuned to the same station, and at least two of the terminals will collaboratively calculate the fingerprints. In one embodiment, the terminals can ensure they are actually tuned to the same station by utilizing a station directory service 332. In addition, location information may optionally be used to confirm radio station identification information as is described more fully below.

As shown in FIG. 3B, the station directory service (SDS) 332 can ensure that all N terminals 300, 302, 306 are indeed tuned to the same station. For example, the SDS 332 can provide a directory of available stations to each of the terminals 300, 302, 306. The directory may include, for example, the station frequency and visual channel ID. The terminal users can then select a station from the directory, and an application sets the correct frequency for the local tuner. In this manner, it is known what station the user is tuned to.

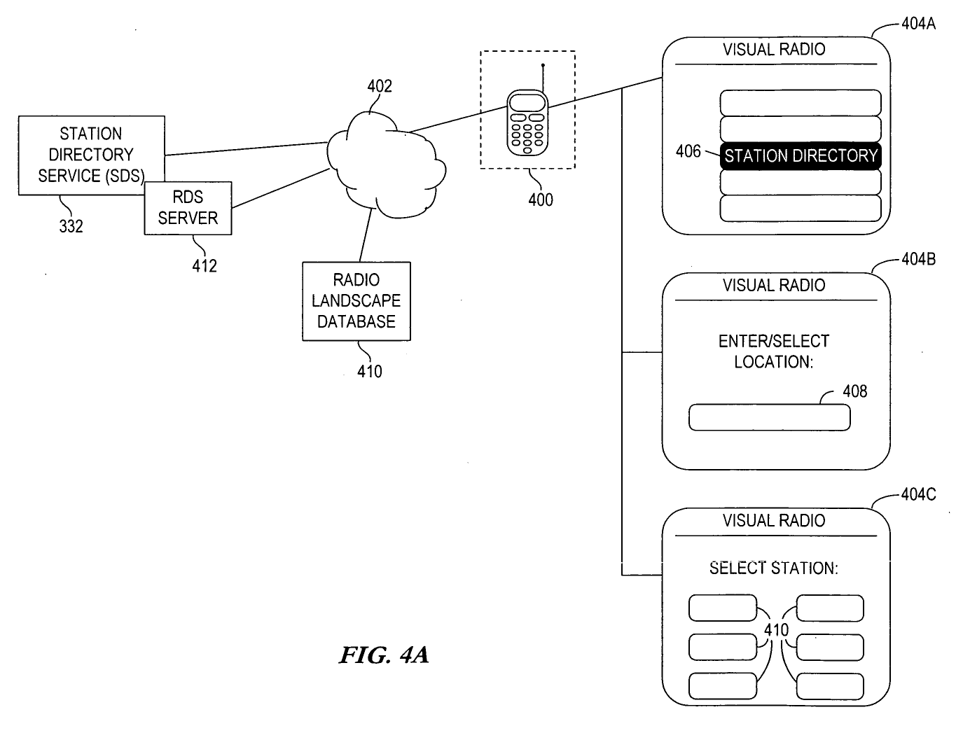

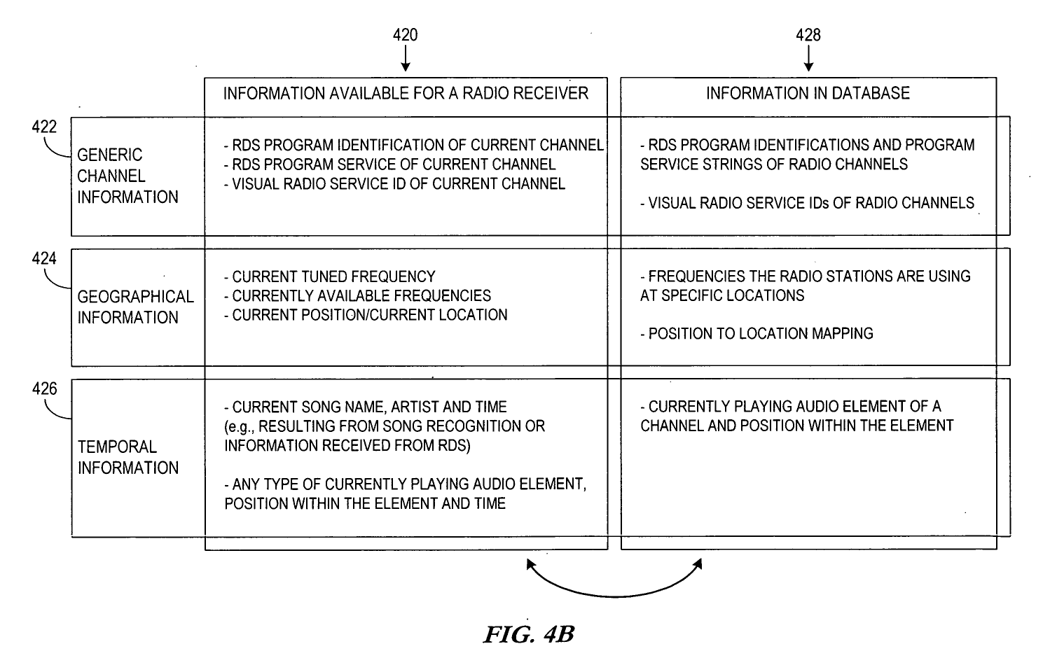

An example of the user's interaction to select a station in this manner is depicted in FIG. 4A. The station directory service (SDS) 332 is depicted as a network element available to a mobile terminal(s) 400 via one or more networks 402 such as the Internet, GSM/GPRS network, wireless local area network (WLAN) or any other network(s) capable of communicating data. The terminal 400 includes a display to present screen images, shown in FIG. 4A as screen images 404A, 404B, 404C. Screen image 404A illustrates a representative graphical user interface (GUI) enabling the user to select a station directory 406 application. The application may ask the user to enter 408 or otherwise designate a current location. The location may be relevant in media situations such as where the content in question is radio, as the radio station inherently has a finite transmission range and the same radio frequency may be used for multiple radio stations in different areas. Thus, by identifying the current location of the user/terminal, the radio stations in that location or area are the available stations from which the user can listen. The user may enter a known station frequency in the area or may designate a desired station in other manners, such as by selecting from a plurality of presented radio stations 410 available in the area as shown at screen image 404C. When the user enters/selects a station 410, and the location is known, this enables the SDS 332 or other entity to track which terminals are tuned to a particular station so that the fingerprinting task can be appropriately allocated among those terminals.

One embodiment recognizes that the user can enter/select: an incorrect location 408. There is always the possibility of the user erroneously entering the wrong location, or that the user simply does not know the location at the level of detail being requested. For example, if the location entry 408 requires a ZIP code, the user may not know the ZIP code for the current location, particularly if the user is traveling. There are numerous reasons why a location can be entered or selected incorrectly it the user terminal. In such cases, other options can be alternatively or additionally used to assist in determining the user's current location. In one embodiment, the user may be tuned to a radio station frequency, and the location of the mobile terminal itself can be determined rather than entered by the user. Location data may be obtained using, for example, global positioning system (GPS) information if the terminal is so equipped. Such data may also be obtained using cell identification (ID) information, since a cellular network will know the location of the terminal for purposes of locating the terminal if an incoming call occurs. Because a radio station transmission range is relatively large and does not typically involve precise transmission range boundaries, great precision in the terminal's location is not required, and locations such as the location based on cell ID is suitable in one embodiment. Other location services may alternatively/additionally be implemented. In any event, the radio station frequency and location data is known for a terminal which can be sent to the SDS 332 to obtain the station name and visual channel ID.

Another embodiment is an RDS-assisted embodiment, where Radio Data System (RDS) information is utilized. As is known, RDS or other analogous services involve sending small amounts of data via radio broadcasts, such as FM broadcasts. Such systems may include standard information, such as time and station identification. For any such system providing a station identification/name, the station name can be used to ensure that the terminal is tuned to the correct station. An RDS (or analogous) server 412 is shown in FIG. 4A, which can provide the information to the relevant terminal 400.

Still another representative embodiment for identifying the radio station to which a terminal is tuned is to statistically identify whether a terminal is tuned to the station that it professes to be tuned. For example, assume that one hundred terminals indicate that they are tuned to Radio Station-A at frequency-A. If some designated majority (e.g., 90%) of those terminals that are supposedly tuned to Radio Station-A are reporting the same song/content, then it can be assumed that any other terminals that are supposedly tuned to Radio Station-A, but are reporting a different song than the majority, are in fact not tuned to Radio Station-A. This may be because, for example, the minority terminals incorrectly identified their location in the first place, or the terminal roamed out of the area such that another radio station at the same frequency became the dominant radio signal. In such cases, the visual radio system can ignore the fingerprint data provided by those seemingly deviant terminals, and rely on the fingerprint data provided by the terminals that statistically suggest location accuracy.

The fingerprinting task may be distributed substantially evenly among the terminals, or may be distributed in a weighted manner. For example, the task may be weighted more heavily to terminals having better reception for any reason such as proximity to the radio station, design, battery power, etc. In one embodiment, the fingerprinting task is distributed substantially evenly among the terminals tuned to the station frequency in the relevant area.

As noted above, the invention enables content such as visual content to be obtained for related content provided by any media station, by generating fingerprints and using those fingerprints to directly or indirectly identify the desired content in a content database. The frequency or other channel that each terminal is tuned to should be determined so the fingerprint task can be distributed appropriately. There is no prior art solution to reliably determine which channel a terminal is tuned to, as the same frequency may be used in a different geographical location. Thus, frequency tuning is not enough, as the location or other parameters must be ascertained to reliably determine which station a device is tuned to.

One embodiment of the invention enables reliable determination of the tuned channel by collecting information available in the radio landscape and comparing that to a database 410 populated with radio landscape information. In the context of broadcast radio, each radio station is associated with a globally-unique identifier. One aspect of the invention contemplates manners of determining this globally-unique identifier, the knowledge of which provides a reliable indication of the terminal's current location. Knowing the frequency that the terminal is tuned to, and knowing the terminal's current location, a reliable determination of the radio station to which a terminal is tuned can be made. The fingerprinting task can then be properly distributed among those terminals tuned to the same station (and thereby listening to the same song).

In one embodiment information available regarding the radio channel landscape is used to reliably determine the globally-unique radio channel identity. This information may include any one or more of the following representative types of information. For example, the radio receiver at a terminal can detect the current frequency that the receiver is tuned to, so the tuned frequency represents one type of information usable to determine the globally-unique radio channel identity. Another example is that the radio receiver may detect the RDS identity of the current channel. Further, the radio receiver can scan and detect all the frequencies of the channels that it could tune into at it's current location. If desired, scanning can be effected with different levels of sensitivity to determine the large landscape and/or the local landscape. The radio receiver may scan and detect the RDS identity of the currently-available channels with RDS enabled. The radio receivers may provide their geographic position, such as via GPS technology. In another embodiment, the receiver can record an audio sample of the current broadcast. The radio receiver may recognize the current audio element, for example the currently playing song, the time and the position within the audio element. A mobile terminal can provide additional information that can be used to limit the geographical area and possible set of radio stations. This information may include, for example, the positioning data or information relating to coordinates and/or mobile cell ID, operator name operator ID, etc.

This and/or other such information can be used in determining the globally-unique identity of the channel. Not all of the information need be provided, but rather numerous subsets of the information can be sufficient to arrive at the globally-unique identity of the channel. Some information may be easier for the terminal to acquire than others, such as the current channel frequency. The current channel frequency is a piece of information that is typically available to a radio receiver. The radio receiver can then scan and automatically detect other radio stations that exist in area. Some information may be lacking due to missing hardware or service support; for example a positioning system such as GPS.

Information relative to a particular mobile terminal, such as the list of recognized radio frequencies and corresponding signal strength data for all of the radio stations in the terminal's vicinity, can be referred to as the radio landscape fingerprint. This list of received stations and signal strength can in a relatively unique fashion identify the position of the radio receiver. For example, if a radio receiver can pick up a particular eight radio stations, the radio receiver must be within a certain transmission range of each of the radio stations and thus the radio receiver's approximate location can be determined. In accordance with one embodiment of the invention, the database 410 may be provided with such radio channel landscape information. The radio landscape fingerprint from a radio receiver can be matched against the database 410 to determine the radio receiver's approximate location, and the globally-unique identity of the channel that it is tuned into. In one embodiment, the terminal 400 can obtain the list of radio frequencies at particular geographic locations from a database such as the station directory service 332. Such a database 332 may include, for example, a database of radio stations around the world and their corresponding frequencies at particular geographic locations (e.g., cities, approximate coordinate boundaries, etc.).

A mobile terminal equipped with a radio receiver can compile a collection of available landscape information such as the current frequency, other available frequencies, the RDS information of all available frequencies, current location, the currently playing song, etc. These and other types of information available for a radio receiver are shown in FIG. 4B, column 420. For example, generic channel information 422 includes information such as the RDS program identification of the Current channel, the RDS program service of the current channel, the visual radio service ID of the current channel, etc. Geographical information 424 may include the current tuned frequency, currently available frequencies, current position/location, etc. Temporal information 426 may include the current song name, artist, time, etc. This information may be received, for example, as a result of a song recognition or information received from RDS. Another example of temporal information 426 is any type of currently playing audio element and position within the element and time.

When at least some of such information is collected, a query is made by the radio receiver to the radio landscape database 410 with the compilation of information. In one embodiment the database 410 is available via a network(s) 402, but can alternatively be a database locally at the radio receiver; i.e., at the mobile terminal. The radio landscape database 410 may be associated with a server that tries to match the provided compilation of information with the information stored at the database 410. Representative examples of the type of information that may be stored at the database 410 is shown in FIG. 4B, column 428. For example, the generic channel information 422 in the database 410 that may correlate to the information 420 provided by the terminal may include RDS program identifications and program service strings of radio channels, visual radio service IDs of radio channels, etc. The geographic information 424 in the database 410 that may correlate to the information 420 provided by the terminal may include frequencies the radio stations are using at specific locations, position-to-location mapping, etc. The temporal information 426 in the database 410 that may correlate to the information 420 provided by the terminal may include the currently playing audio element of a channel and position within the element.

Regardless of the particular information used, the information available for a radio receiver (e.g., examples shown in column 420) is mapped against the information in the database (e.g., examples shown in column 428) to determine the globally-unique identity of the channel. If a match is found, the identify of the channel is returned to the mobile terminal. In this manner, a high degree of confidence is achieved in the actual radio station to which the terminal is tuned. On the terminal side, one exemplary implementation is a C++ or java application that utilizes services in the mobile terminal, such as an FM tuner that is RDS enabled, positioning services of the terminal, etc.

Thus, an improved manner of acquiring radio channel identity is provided, which allows the fingerprinting task to be allocated among those terminals determined to be tuned to the same radio channel. This provides an automated method that does not require terminal user actions, and is not prone to intentional or unintentional incorrect location selections by terminal users. The solution does not require RDS for the radio stations, nor does the solution require proprietary extensions of radio stations or globally unique RDS identifiers for the RDS data elements. The solution also does not require that radio stations maintain up-to-date RDS data elements.

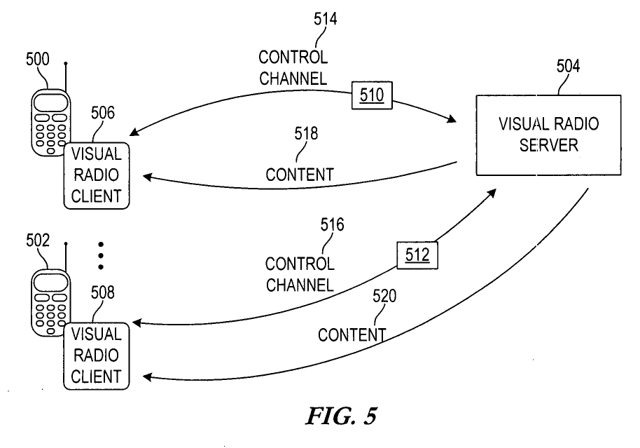

The use of a control channel and corresponding control protocol to distribute the fingerprinting task among a plurality of terminals is generally illustrated in FIG. 5. In order to support even distribution of the fingerprint calculation task among a plurality of terminals 500, 502, a control protocol may be implemented by the server 504 providing the visual content (e.g., visual radio server) and corresponding visual radio client application 506, 508. In one embodiment, information can be exchanged between the server 504 and clients 506, 508 via one or more messages 510, 512 passed in a control channel 514, 516. For example, in one embodiment, terminals 500, 502 capable of recognizing and presenting visual radio information (hereinafter referred to as a visual radio terminal or VR terminal) includes a socket connection to the visual radio server 504 which can be used to communicate control data and the fingerprint data.

In one embodiment, the use of the control channel 514, 516 and the passing of messages 510, 512 is server controlled. For example, in one embodiment the visual radio server 504 is aware of the number of terminals 500, 502 listening to the same station, and can make a decision regarding calculation start times and intervals for each of the terminals so that it obtains a sufficient quantity of fingerprint data to identify the media (e.g., song). In such an embodiment, the server 504 can send to each terminal 500, 502 a message 510, 512 with the period for the fingerprint calculation and the starting time. A programming example is shown in Example 1 below:

```
<fingerprint action=“start”>
    <start time>10:07:15</starttime>
    <interval>100seconds</interval>
</fingerprint>
```

### EXAMPLE 1

The server 504 can later change the calculation timing for some of the terminals by re-sending a command. An example is shown in Example 2 below:
<fingerprint action=“restart”>

### EXAMPLE 2

In response to such messages, content 518, 520 is returned from the server 504 to the client 506, 508. In a visual radio embodiment, such content may include any one or more of a song title, artist, length of song, etc.

It is possible that some terminals may disconnect from the distributed fingerprinting task while other terminals are joining. In one embodiment, the server 504 has the responsibility to maintain the fingerprint distribution as evenly as possible, although there is no need for precision and superfluous data will only improve the recognition quality. Thus, if the number of participating terminals is reduced, the server 504 may, for example, add time to the fingerprinting calculation interval for the terminals.

In one embodiment, the use of the control channel 514, 516 and the passing of messages 510, 512 is terminal controlled. For example, in one embodiment the terminal itself can make a decision on the start time and interval of the fingerprint calculation. As an example, the start time can be a random value, and the period can be s;et to the time synchronization interval. If number of terminals is large enough, then statistically there will be sufficient fingerprint data provided to the server to for adequate song/media recognition, such as in the case of Gaussian distribution. The terminal can send one or more complete or partial fingerprints in a discrete message(s), or may send the one or more complete or partial fingerprints to the server together with another message(s) already being sent via the control channel (e.g., time synchronization message) in order to conserve bandwidth. For example, the time synchronization message or “keep alive” message is part of existing radio communication protocols for a visual radio control channel, and is sent periodically to ensure that the terminal is still connected and operational. The fingerprint(s) may be sent with this or other existing traffic, or may be sent independently of existing traffic.

In another embodiment, a combination of server control and terminal control may be utilized. For example, in one embodiment the terminal can select a random value for the start interval using the “keep alive” interval. The server can determine the success of the results, and if the server is not satisfied it can set a new interval by sending an appropriate command (e.g., <fingerprint action=“restart”>). Memory can also be implemented to store the previous interval for later use.

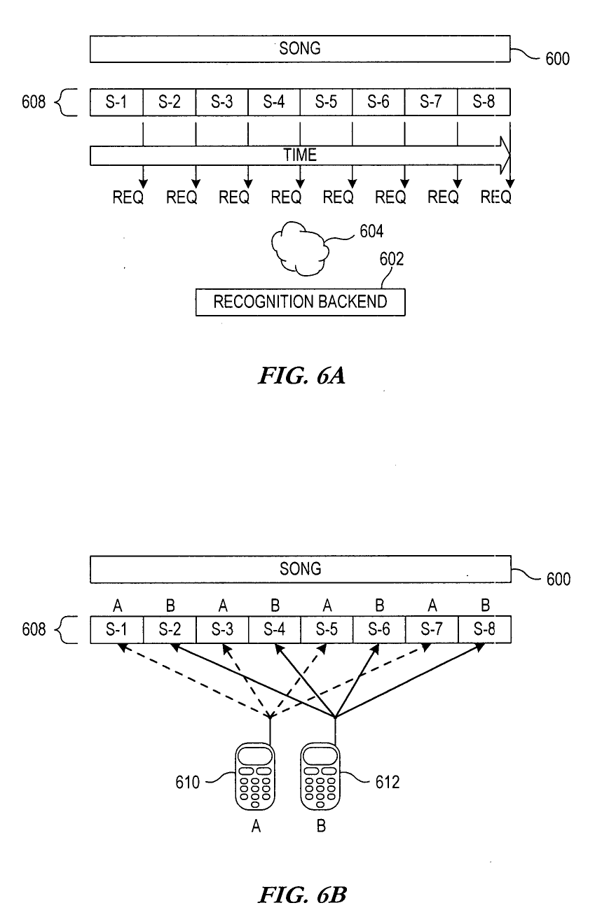

FIG. 6A illustrates an exemplary manner of recognizing fingerprints to identify an audio item in accordance with the invention. A signal 600, such as a radio signal, may include a song, advertisement or other content. In one embodiment, recognition is accomplished by sampling a substantially fixed period of the audio stream 600. For example, a fingerprint extractor module can be provided at each participating mobile terminal to sample the audio stream 600, as depicted by samples S-1, S-2, S-3, S-4, S-5, S-6, S-7 and S-8. Multiple terminals are involved in the sampling process in accordance with the present invention, to share the fingerprint task. The fingerprint extractor module can be, for example, a software/firmware program(s) executable via a processor(s). The fingerprint extractor may calculate a sample of, for example, several seconds although the particular duration may vary. Longer durations may produce more accurate results. In one embodiment, at the end of a sampling period, a request (REQ) is sent to the recognition backend 602, such as a recognition server that looks up the song or other content item in a database based on the fingerprint sample(s). In one embodiment, the requests (REQ) are first sent via a network(s) 604 from the terminal to a server such as a visual radio server which in turn forwards the request to a recognition server (e.g., server 324 of FIGS. 3A and 3B).

As can be seen from FIG. 6A, if each of the terminals is performing a fingerprint calculation for the entire stream 608, calculations would be performed that might not be needed. For example, if one hundred terminals each perform a full fingerprint analysis on a song broadcast via FM radio, then all one hundred terminals utilizes the processing and battery power required to perform the entire fingerprint calculation. This also causes excessive load on the server, as it receives one hundred fingerprint analysis results. This also clearly burdens the network, as bandwidth is consumed by transmitting multiple versions of the same fingerprint analysis data. By distributing the fingerprint task and providing a collective fingerprint stream to the server, these and other burdens on the server component, network and terminals can be significantly reduced.

The sharing of the fingerprint distribution task is shown in FIG. 6B which uses like reference numbers to those in FIG. 6A where appropriate. In the example of FIG. 6B, two mobile terminals 610, 612 share the fingerprint calculation task, although a greater number of terminals may share the task. In the illustrated embodiment, two terminals 610, 612 collectively generate one fingerprint stream 608, which includes samples taken from each of the terminals 610, 612. For example, terminal 610 is given the label of “A” and terminal 612 is given the label of “B.” The terminals 610, 612 distribute the fingerprint generation task between them, such that terminal A 610 performs the fingerprint calculation for samples S-1, S-3, S-5, S-7 and terminal B 612 performs the fingerprint calculation for samples S-2, S-4, S-6, S-8. In this manner, only half of the fingerprint samples are calculated and sent by each terminal 610, 612.

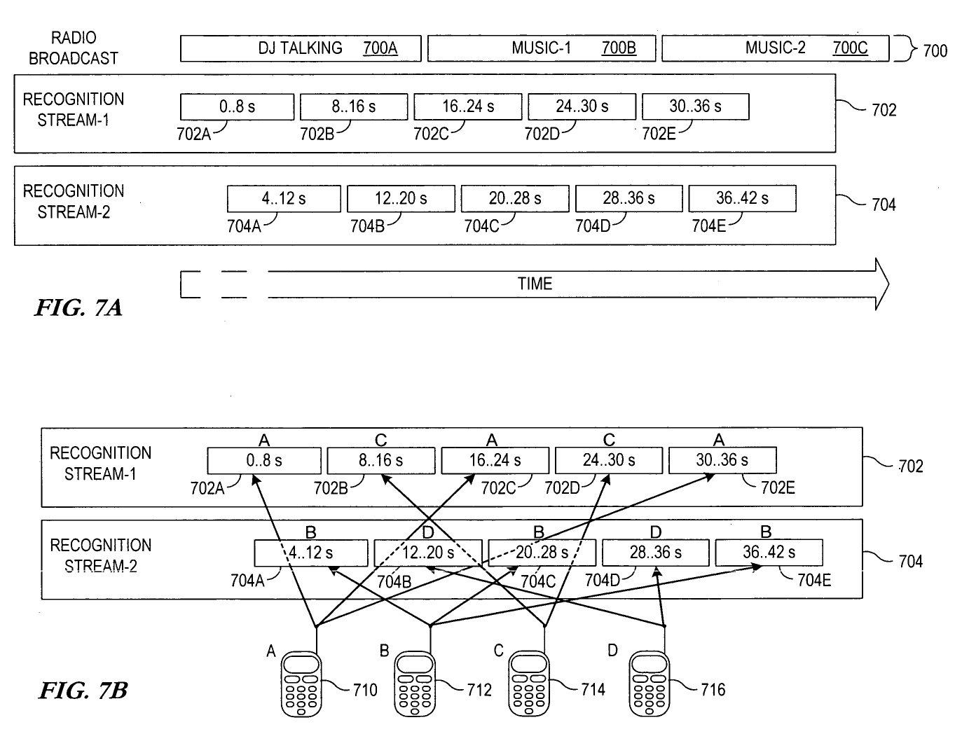

In another embodiment, multiple streams of fingerprints can be provided to facilitate faster recognition at the recognition backend. For example, FIG. 7A shows a media broadcast, such as a radio broadcast 700. The radio broadcast 700 may include content that is not searchable for related visual content such as disk jockey communications 700A, and content that is searchable for related visual content such as songs 700B, 700C. Using multiple recognition streams, such as recognition stream-1 702 and recognition stream-2 704 can decrease the length of the start and stop delays in providing the visual content. For example, multiple recognition streams offset in time can enable the receiving server(s), including a music recognition server, to more quickly identify the content in a database. In the illustrated embodiment, recognition stream-I 702 includes a first eight second sample 702A taken from 0 seconds to 8 seconds, a second sample 702B taken from 8 seconds to 16 seconds, and so forth for the remaining samples 702C, 702D, 702E, etc. Similarly, recognition stream-2 704 includes a first sample 704A taken from 4 to 12 seconds, a second sample 704B taken from 12 seconds to 20 seconds, and so forth for the remaining samples 704C, 704D, etc.

In one embodiment, the samples are overlapping as shown in FIG. 7A. The resulting two (or more) fingerprint calculation results 702, 704 are ultimately provided to a music recognition server, which on average can locate the associated content more quickly than if only a single fingerprint result stream was used. This is due to the offset in time between the recognition stream samples, and that during each sampling period two (or more) recognition events are generated. In the example of FIG. 7A, two recognition streams are depicted although more may be used.

FIG. 7B illustrates a representative example of using multiple streams of fingerprints and also distributing the fingerprinting task among a plurality of terminals. Particularly, the illustrated embodiment includes four terminals, namely terminal A 710, terminal B 712, terminal C 714, and terminal D 716. The sharing of the fingerprint distribution task is shown in FIG. 7B which uses like reference numbers to those in FIG. 7A where appropriate. In the example of FIG. 7B, the four mobile terminals 710, 712, 714, 716 share the fingerprint calculation task, although a greater or fewer number of terminals may share the task. In the illustrated embodiment, the four terminals collectively generate multiple fingerprint streams 702, 704, which includes samples taken from each of the terminals 710, 712, 714, 716. For example, terminal 710 is given the label of “A,” terminal 712 is given the label of“B,” terminal 714 is given the label of “C,” and terminal 716 is given the label of “D.” In the illustrated embodiment, terminal A 710 performs the fingerprint calculation for samples 702A, 702C and 702E; terminal B 710 performs the fingerprint calculation for samples 704A, 704C and 704E; terminal C 714 performs the fingerprint calculation for samples 702B and 702D; and terminal D 710 performs the fingerprint calculation for samples 704B and 704D. As can be seen, terminals A 710 and C 714 create the first recognition stream-1 702, and terminals B 712 and D 716 create the second recognition stream-2 704. Thus, the load for two recognition streams is distributed between four terminals. While the total quantity of fingerprint packets sent in the illustrated embodiment is ten, each terminal sends only two or three packets of the ten, while still providing dual offset recognition streams to the music recognition server.

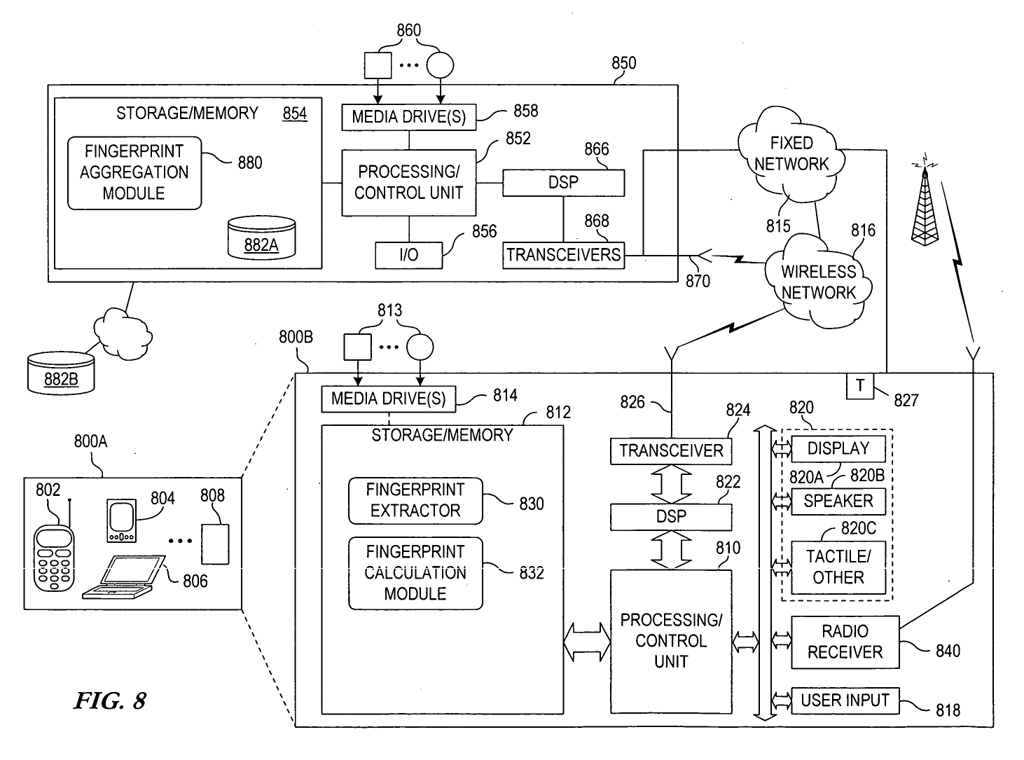

A representative system in which the present invention may be implemented or otherwise utilized is illustrated in FIG. 8. The communication device(s) 800A represents any communication device capable of performing the device/terminal functions previously described. In the illustrated embodiment, the device 800A represents a mobile device capable of communicating over-the-air (OTA) with wireless networks and/or capable of communicating via wired networks. By way of example and not of limitation, the device 800A includes mobile phones (including smart phones) 802, personal digital assistants 804, computing devices 806, and other networked terminals 808.

The representative terminal 800A utilizes computing systems to control and manage the conventional device activity as well as the device functionality provided by the present invention. For example, the representative wireless terminal 800B includes a processing/control unit 810, such as a microprocessor, controller, reduced instruction set computer (RISC), or other central processing module. The processing unit 810 need not be a single device, and may include one or more processors. For example, the processing unit may include a master processor and one-or more associated slave processors coupled to communicate with the master processor.

The processing unit 810 controls the basic functions of the terminal 800B as dictated by programs available in the program storage/memory 812. The storage/memory 812 may include an operating system and various program and data modules associated with the present invention. In one embodiment of the invention, the programs are stored in non-volatile electrically-erasable, programmable read-only memory (EEPROM), flash ROM, etc., so that the programs are not lost upon power down of the terminal. The storage 812 may also include one or more of other types of read-only memory (1ROM) and programmable and/or erasable ROM, random access memory (RAM), subscriber interface module (SIM), wireless interface module (WIM), smart card, or other fix,ed or removable memory device/media. The programs may also be provided via other media 813, such as disks, CD-ROM, DVD, or the like, which are read by the appropriate interfaces and/or media drive(s) 814. The relevant software for carrying out terminal operations in accordance with the present invention may also be transmitted to the terminal 800B via data signals, such as being downloaded electronically via one or more networks, such as the data network 815 or other data networks, and an intermediate wireless network(s) 816 in the case where the terminal 800A/800B is a wireless device such as a mobile phone.

For performing other standard terminal functions, the processor 810 is also coupled to user input interface 818 associated with the terminal 800B. The user input interface 818 may include, for example, a keypad, function buttons, joystick, scrolling mechanism (e.g., mouse, trackball), touch pad/screen, or other user entry mechanisms (not shown).

A user interface (UI) 820 may be provided, which allows the user of the terminal 800A/B to perceive information visually, audibly, through touch, etc. For example, one or more display devices 820A may be associated with the terminal 800B. The display 820A can display web pages, images, video, text, links, visual radio information and/or other information. A speaker(s) 820B may be provided to audibly present instructions, information, radio or other audio broadcasts, etc. Other user interface (UI) mechanisms can also be provided, such as tactile 820C or other feedback.

The exemplary mobile device 800B of FIG. 8 also includes conventional circuitry for performing wireless transmissions over the wireless network(s) 816. The DSP 822 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 824 includes at least a transmitter and receiver, thereby transmitting outgoing wireless communication signals and receiving incoming wireless communication signals, generally by way of an antenna 826. Where the device 800B is a non-mobile or mobile device, it may include a transceiver (T) 827 to allow other types of wireless, or wired, communication with networks such as the Internet. For example, the device 800B may communicate via a proximity network (e.g., IEEE 802.11 or other wireless local area network), which is then coupled to a fixed network 815 such as the Internet. Peer-to-peer networking may also be employed. Further, a wired connection may include, for example, an Ethernet connection to a network such as the Internet. These and other manners of ultimately communicating between the device 800A/B and the server 850 may be implemented.

In one embodiment, the storage/memory 812 stores the various client programs and data used in connection with the present invention. For example, a fingerprint extractor module 830 can be provided at the device 800B to sample an audio stream received by way of a broadcast receiver, such as the radio receiver/tuner 840. The device 800B includes a fingerprint calculation module 832 to generate the fingerprint portions previously described. These and other modules may be separate modules operable in connection with the processor 810, may be a single module performing each of these functions, or may include a plurality of such modules performing the various functions. In other words, while the modules are shown as multiple software/firmware modules, these modules may or may not reside in the same software/firmware program. It should also be recognized that one or more of these functions may be performed using hardware. For example, a compare function may be performed by comparing the contents of hardware registers or other memory locations using hardware compare functions. These modules are representative of the types of functional and data modules that may be associated with a terminal in accordance with the invention, and are not intended to represent an exhaustive list. Also, other functions not specifically shown may be implemented by the processor 810.

FIG. 8 also depicts a representative computing system 850 operable on the network. One or more of such systems 850 may be available via a network(s) such as the wireless 816 and/or fixed network 815. In one embodiment, the computing system 850 represents the visual radio server as previously described, or may represent a music recognition server or other computing system. The system 850 may be at single system or a distributed system. The illustrated computing system 850 includes a processing arrangement 852, which may be coupled to the storage/memory 854. The processor 852 carries out a variety of standard computing functions as is known in the ant, as dictated by software and/or firmware instructions. The storage/memory 854 may represent firmware, media storage, and/or memory. The processor 852 may communicate with other internal and external components through input/output (I/O) circuitry 856. The computing system 850 may also include media drives 858, such as hard and floppy disk drives, CD-ROM drives, DVD drives, and other media 860 capable of reading and/or storing information. In one embodiment, software for carrying out the operations at the computing system 850 in accordance with the present invention may be stored and distributed on CD-ROM, diskette, magnetic media, removable memory, or other form of media capable of portably storing information, as represented by media devices 860. Such software may also be transmitted to the system 850 via data signals, such as being downloaded electronically via a network such as the data network 815, Local Area Network (LAN) (not shown), wireless network 816, and/or any combination thereof. In accordance with one embodiment of the invention, the storage/memory 854 and/or media devices 860 store the various programs and data used in connection with the present invention, depending on whether the system 850 represents the visual radio server, music recognition server, content server, etc. For example, in the context of a visual radio server, the storage/memory 854 may include a fingerprint aggregation module 880 to create an aggregate fingerprint from a plurality of partial, incomplete fingerprints provided by a plurality of terminals. Further, in the context of a visual radio server, the storage/memory 854 may include a music database 882A where the desired content is stored and located using the aggregate fingerprint. Alternatively, such a database 882B may be in a separate server, such as a music recognition server accessible via a network or otherwise.

The illustrated computing system 850 also includes DSP circuitry 866, and at least one transceiver 868 (which of course is intended to also refer to discrete transmitter/receiver components). While the server 850 may communicate with the data network 815 via wired connections, the server may also/instead be equipped with transceivers 868 to communicate with wireless networks 816 whereby an antenna 870 may be used.

Hardware, firmware, software or a combination thereof may be used to perform the functions and operations in accordance with the invention. Using the foregoing specification, some embodiments of the invention may be implemented as a machine, process, or article of manufacture by using standard programming and/or engineering techniques to produce programming software, firmware, hardware or any combination thereof. Any resulting program(s), having computer-readable program code, may be embodied within one or more computer-usable media such as memory devices or transmitting devices, thereby making a computer program product, computer-readable medium, or other article of manufacture according to the invention. As such, the terms “computer-readable medium,” “computer program product,” or other analogous language are intended to encompass a computer program existing permanently, temporarily, or transitorily on any computer-usable medium such as on any memory device or in any transmitting device.

From the description provided herein, those skilled in the art are readily able to combine software created as described with appropriate general purpose or special purpose computer hardware to create a computing system and/or computing subcomponents embodying the invention, and to create a computing system(s) and/or computing subcomponents for carrying out the method(s) of the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method comprising:
distributing a task of calculating a plurality of fingerprint portions corresponding to a media stream among a plurality of terminals;
aggregating the plurality of calculated fingerprint portions to create at least one stream of fingerprints; and
identifying content corresponding to the media stream using at least a portion of the at least one stream of fingerprints.

2. The method of claim 1, wherein one or more of the fingerprint portions comprise partial fingerprints forming less than a complete fingerprint, arid wherein aggregating the plurality of calculated fingerprint portions comprises deriving at least one complete fingerprint based on an aggregation of a plurality of the partial fingerprints.

3. The method of claim 1, wherein one or more of the fingerprint portions comprise complete fingerprints each capable of identifying the media stream.

4. The method of claim 1, wherein aggregating the plurality of calculated fingerprint portions comprises forming an end-to-end chain of the calculated fingerprint portions from the plurality of terminals to create a substantially continuous stream of the fingerprints.

5. The method of claim 4, wherein identifying content corresponding to the media stream comprises using the substantially continuous stream of fingerprints to identify changes in the media stream.

6. The method of claim 5, wherein using the substantially continuous stream of fingerprints to identify changes in the media stream comprises identifying a change from one media item to another media item based on a change in the substantially continuous stream of fingerprints provided by the plurality of terminals.

7. The method of claim 1, wherein:
distributing a task of calculating a plurality of fingerprint portions corresponding to a media stream comprises distributing the task of calculating the plurality of fingerprint portions of an over-the-air radio broadcast among the plurality of terminals; and
identifying content corresponding to the media stream comprises identifying visual information associated with an audio track of the radio broadcast being presented on the plurality of terminals.

8. The method of claim 7, further comprising determining which terminals are tuned to the radio broadcast to identify the plurality of terminals that will calculate the plurality of fingerprint portions.

9. The method of claim 1, further comprising transmitting the plurality of calculated fingerprint portions in a single fingerprint stream for remote identification of the content associated with the media stream.

10. The method of claim 1, further comprising transmitting the plurality of calculated fingerprint portions in a plurality of fingerprint streams facilitate parallel identification of the content associated with the media stream.

11. The method of claim 10, further comprising temporally overlapping the calculated fingerprint portions of the plurality of fingerprint streams.

12. The method of claim 1, further comprising transmitting the identified content to each of the plurality of terminals involved in the calculation of the fingerprint portions.

13. The method of claim 1, wherein calculating a plurality of fingerprint portions of different content fingerprint portions comprises each of the plurality of terminals generating one or more different digital packets of information indicative of respective audio segments of the media stream occurring at different time intervals.

14. The method of claim 1, wherein one or more of the different fingerprint portions comprise at least some overlapping fingerprint data.

15. A method comprising:
receiving an over-the-air media stream including at least one audio component;
identifying a subset of the audio component that has been allocated for processing;
calculating at least one digital fingerprint for the identified subset of the audio component; and
transmitting the at least one digital fingerprint.

16. The method of claim 15, wherein identifying a subset of the audio component that has been allocated for processing comprises identifying the subset of the audio component in response to receipt of a fingerprint distribution notification.

17. The method of claim 16, further comprising receiving the fingerprint distribution notification from a server via a network.

18. The method of claim 15, wherein transmitting the at least one digital fingerprint comprises transmitting the calculated one or more digital fingerprints to a processing system capable of recognizing a fingerprint stream including the calculated one or more digital fingerprints and other calculated digital fingerprints based on other subsets of the audio component.

19. The method of claim 15, wherein receiving an over-the-air media stream including at least an audio signal comprises receiving a radio broadcast signal of a song, and wherein identifying a subset of the audio component comprises identifying one or more time intervals of the song in which a respective one or more digital fingerprints are to be calculated.

20. The method of claim 15, wherein transmitting the at least one digital fingerprint comprises transmitting one or more of the calculated digital fingerprints as time multiplexed portions of a single fingerprint stream.

21. The method of claim 15, wherein transmitting the at least one digital fingerprint comprises transmitting one or more of the calculated digital fingerprints as time multiplexed portions of multiple fingerprint streams.

22. The method of claim 15, further comprising:
audibly presenting at least the audio component of the media stream;
receiving content identified in response to the transmission of the at least one digital fingerprint; and
presenting the received content during at least some of the audible presentation of the audio component of the media stream.

23. The method of claim 15, wherein the method is carried out via a mobile terminal, and further comprising providing a radio landscape data set including information indicative of a location of the mobile terminal.

24. The method of claim 15, further comprising determining when to create the one or more digital fingerprints.

25. The method of claim 15, further comprising:
transmitting location parameters;
receiving an indication of a current location generated in response to the location parameters; and
identifying a globally-unique radio station identifier to which a radio receiver is tuned based on the current location and a frequency to which the radio receiver is tuned.

26. A method comprising:
receiving a plurality of content fingerprint portions from a plurality of mobile terminals, each content fingerprint portion representative of a portion of a media stream;
locating digital information using one or more of the plurality of content fingerprint portions; and
transmitting the located digital information for use by the plurality of mobile terminals.

27. The method of claim 26, wherein one or more of the content fingerprint portions comprise partial fingerprints forming less than a complete fingerprint, and wherein aggregating the plurality of calculated fingerprint portions comprises deriving at least one complete fingerprint based on an aggregation of a plurality of the partial fingerprints.

28. The method of claim 26, wherein one or more of the content fingerprint portions comprise complete fingerprints each capable of identifying the media stream.

29. The method of claim 26, further comprising notifying the plurality of mobile terminals which portion of the media stream in which it should create a partial content fingerprint.

30. The method of claim 26, wherein receiving a plurality of partial content fingerprints comprises receiving the plurality of partial content fingerprints via a single data stream.

31. The method of claim 26, wherein receiving a plurality of partial content fingerprints comprises receiving the plurality of partial content fingerprints via multiple parallel data streams.

32. The method of claim 31, wherein receiving the plurality of partial content fingerprints via multiple parallel data streams comprises receiving a first data stream of concatenated fingerprint samples, and receiving one or more second data streams different concatenated fingerprint samples.

33. The method of claim 32, wherein the concatenated fingerprint samples from the first and second data streams are temporally overlapping.

34. The method of claim 26, wherein creating a content fingerprint from at least some of the partial content fingerprints comprises aggregating at least some of the partial content fingerprints.

35. The method of claim 26, further comprising determining a radio station to which each of the plurality of terminals is tuned.

36. An apparatus comprising:
a radio receiver to receive an over-the-air media stream;
a fingerprint extraction module configured to sample a subset of the media stream;
a fingerprint calculation module to generate fingerprints tar each of the portions sampled; and
a transmitter to transmit the generated fingerprints.

37. The apparatus of claim 36, further comprising a data receiver to receive content related to the media stream and identified using the transmitted fingerprints.

38. The apparatus of claim 37, further comprising a display to visually present the received content related to the media stream.

39. The apparatus of claim 38, further comprising a speaker to audibly present the received media stream contemporaneously with the visual presentation of the received content.

40. The apparatus of claim 36, wherein the transmitter further transmits radio landscape data including information indicative of a geographic location of the apparatus.

41. An apparatus comprising:
a receiver to receive a plurality of fingerprints from a respective plurality of terminals, each fingerprint at least partly representative of a media stream;
a processing module configured to locate digital information in a database based on the plurality of fingerprints; and
a transmitter to transmit the digital information for use by the plurality of terminals.

42. An apparatus comprising:
means for receiving an over-the-air media stream;
means for sampling a subset of the media stream;
means for generating fingerprints for each of the portions sampled; and
means for transmitting the generated fingerprints.

43. An apparatus comprising:
means for receiving a plurality of fingerprints from a respective plurality of terminals, each fingerprint at least partly representative of a media stream;
means for locating digital information based on the plurality of fingerprints; and
means for transmitting the digital information for use by the plurality of terminals.
